(19) United States
(12) Patent Application Publication
(10) Pub. No.: US 2018/0024708 A1
(43) Pub. Date: Jan. 25, 2018

(54) METHOD FOR PROVIDING USER INTERFACE RELATED TO NOTE AND ELECTRONIC DEVICE FOR THE SAME

(71) Applicant: Samsung Electronics Co., Ltd., Gyeonggi-do (KR)

(72) Inventors: Hayoung Kim, Seoul (KR); Jieun Yang, Seoul (KR); Jinhee Jeon, Seongnam-si (KR); Jung-Mi Lee, Seoul (KR)

(21) Appl. No.: 15/630,870

(22) Filed: Jun. 22, 2017

(30) Foreign Application Priority Data
Jul. 25, 2016 (KR) 10-2016-0094306

(51) Int. Cl. G06F 3/0482; G06F 3/0354; G06F 3/0488

(52) U.S. Cl. CPC G06F 3/0482; G06F 3/04883; G06F 3/03545

(57) ABSTRACT

An electronic device and method therefor includes a display, a memory, and a processor functionally connected with the display or the memory. The processor is configured to detect a note event in a screen off state, display a first user interface for writing a note on the display, and receive a note writing input from a user. If an object for fixed display included in the first user interface is selected, the processor also is configured to display a second user interface related to a note.

### CROSS-REFERENCE TO RELATED APPLICATION(S) AND CLAIM OF PRIORITY

The present application is related to and based on and claims priority under 35 U.S.C. §119 to Korean Patent Application No. 10-2016-0094306, which was filed in the Korean Intellectual Property Office on Jul. 25, 2016, the contents of which are incorporated herein by reference.

### TECHNICAL FIELD

Various exemplary embodiments relate to a method for providing a user interface related to a note and an electronic device for the same.

### BACKGROUND

With the recent enhancement of digital technology, various types of electronic devices, such as mobile communication terminals, personal digital assistants (PDAs), electronic schedulers, smart phones, tablet personal computers (PCs), wearable devices, or the like, are widely used. Hardware and/or software-based parts of the electronic devices have been continuously enhanced in order to support and increase functions.

For example, electronic devices may be provided with an input and output device for performing an input function and a display function simultaneously like a touch screen, and may provide various functions by utilizing the touch screen. For example, when a specific input (for example, a predetermined touch input, separation of an electronic pen provided in an electronic device) is detected in a display off state (or a screen off state), the electronic device may provide a user interface for inputting a note. A user can easily write a note without unlocking the electronic device or executing a note application to input the note.

If the display of the electronic device is turned on, the user may write a note by executing a note application. When the display of the electronic device is turned off, the user may write a note by making a specific input (for example, a predetermined touch input or separation of an electronic pen provided in the electronic device). Since the note written in the display off state is deleted when a predetermined time elapses, the user cannot edit the note written in the display off state.

### SUMMARY

According to an aspect of the present disclosure, an electronic device includes: a display; a memory; and a processor functionally connected with the display or the memory, and the processor is configured to: detect a note event in a screen off state; display a first user interface for writing a note on the display; receive a note writing input from a user; and, if an object for fixed display included in the first user interface is selected, display a second user interface related to a note.

According to another aspect of the present disclosure, a method for operating of an electronic device includes: detecting a note event in a screen off state; displaying a first user interface for writing a note on the display; receiving a note writing input from a user; and, if an object for fixed display included in the first user interface is selected, displaying a second user interface related to a note.

According to another aspect of the present disclosure, a method for operating of an electronic device includes:

According to various exemplary embodiments, there is provided a user interface through which a user can easily write a note in a screen off state, and can view or edit the written note at any time.

According to various exemplary embodiments, the electronic device can allow a user to easily view or edit a written note without entering a screen on state.

According to various exemplary embodiments, by providing a user interface through which a user can write, view, and edit a note in a screen off state in which an electronic device operates in a low power mode, user convenience can be enhanced.

According to various exemplary embodiments, desired data can be set as a background of a screen off state in which the electronic device operates in a low power mode.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view showing a configuration of an electronic device according to various exemplary embodiments;

FIG. 2 is a flowchart showing a method for operating of an electronic device according to various exemplary embodiments;

FIGS. 3A-3D are views showing examples of a user interface related to a note in a screen off state according to various exemplary embodiments;

FIG. 4 is a flowchart showing a method for providing a user interface related to a note in an electronic device according to various exemplary embodiments;

FIG. 5 is a flowchart showing a method for providing a user interface related to a note edit in an electronic device according to various exemplary embodiments;

FIG. 6 is a flowchart showing a method for controlling a note of an electronic device according to various exemplary embodiments;

FIG. 7 is a flowchart showing a method for setting a screen off background of an electronic device according to various exemplary embodiments;

FIGS. 8A-8C and FIGS. 9A-9C are views showing examples of user interfaces related to setting of a screen off background according to various exemplary embodiments; and

FIG. 10 is a flowchart showing a method for processing to change in an electronic device according to various exemplary embodiments.

### DETAILED DESCRIPTION

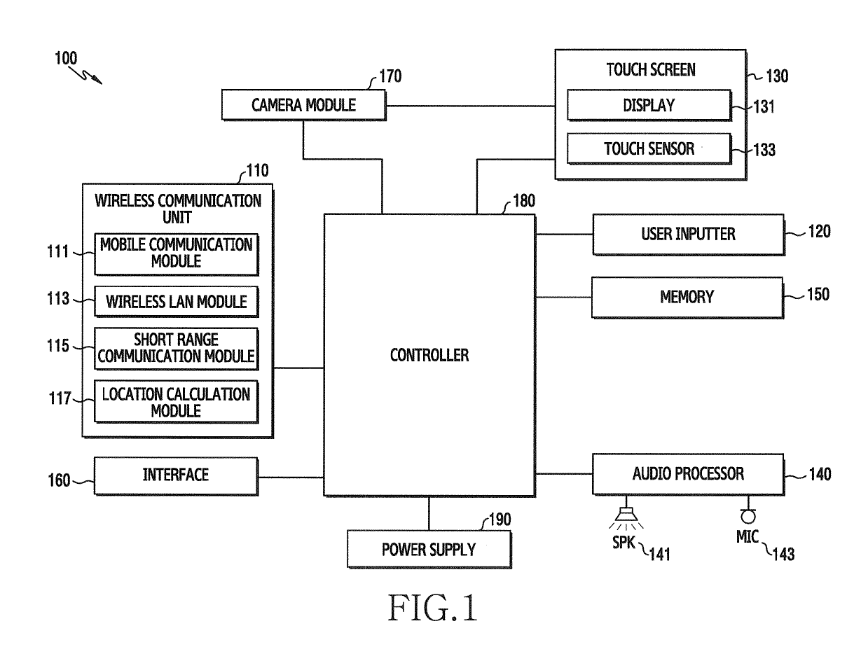

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged configuration.

Various exemplary embodiments of the present disclosure will be described herein below with reference to the accompanying drawings. However, exemplary embodiments and terms used herein are not intended to limit the technical features described in the present disclosure to specific embodiments and should be construed as including modifications, equivalents and/or alternatives of exemplary embodiments of the present disclosure. In the explanation of the drawings, similar reference numerals are used for similar elements. In addition, exemplary embodiments of the present disclosure are suggested for explanation and understanding of the technical features disclosed herein and do not limit the scope of the present disclosure. Accordingly, the scope of the present disclosure should be interpreted as including all changes based on the technical idea of the present disclosure or various other embodiments.

According to an exemplary embodiment of the present disclosure, an electronic device may include all kinds of devices using one or more of various processors, such as an application processor (AP), a communication processor (CP), a graphic processing unit (GPU), and a central processing unit (CPU), like all information and communication devices, multimedia devices, wearable devices, and application devices therefor, which support functions according to various exemplary embodiments of the present disclosure (for example, a display function, a screen off function operating in a low power mode (for example, an always on display)).

An electronic device according to an exemplary embodiment of the present disclosure may include at least one of, for example, smartphones, tablet personal computers (PCs), mobile phones, video telephones, electronic book readers, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, or wearable devices (for example, smart glasses, head-mounted-devices (HMDs), or smart watches).

According to an exemplary embodiment of the present disclosure, the electronic device may be a smart home appliance. For example, the smart home appliance may include at least one of televisions (TVs), digital versatile disc (DVD) players, refrigerators, air conditioners, cleaners, washing machines, set-top boxes, home automation control panels, TV boxes (e.g., Samsung HomeSync™, Apple TV™, or Google TV™), game consoles (e.g., Xbox™ and PlayStation™), or electronic picture frames. In addition, the electronic device according to an exemplary embodiment of the present disclosure may include at least one of navigation devices or Internet of Things.

According to various embodiments, the electronic device may be one of the above-mentioned devices or a combination of one or more devices. According to a certain embodiment, the electronic device may be a flexible electronic device. In addition, the electronic device according to an exemplary embodiment of the present disclosure is not limited to the above-mentioned devices and may include a new electronic device with the enhancement of technology.

In addition, the term “user” used in the various exemplary embodiments may refer to a person who uses the electronic device or a device that uses the electronic device (for example, an artificial intelligence electronic device). A module or a programming module according to various embodiments may include at least one of various elements of the present disclosure, or some of the elements may be omitted, or additional other elements may be further included. Operations performed by a module, a programming module, or other elements according to various embodiments may be executed sequentially, in parallel, repeatedly, or in a heuristic method. Also, a portion of operations may be executed in different sequences, omitted, or other operations may be added.

Hereinafter, a method and an apparatus for providing a user interface related to a note according to various exemplary embodiments of the present disclosure will be described with reference to the accompanying drawings. However, since various exemplary embodiments of the present disclosure are not restricted or limited by the following description, it should be noted that the present disclosure can be applied to various exemplary embodiments based on the following embodiments. In various exemplary embodiments described below, a hardware approach method will be described by way of an example. However, since various exemplary embodiments of the present disclosure include technology that uses both hardware and software, various exemplary embodiments of the present disclosure do not exclude an approach method based on software.

FIG. 1 is a view showing a configuration of an electronic device according to various exemplary embodiments.

Referring to FIG. 1, the electronic device 100 according to various exemplary embodiments of the present disclosure may include a wireless communication unit 110, a user input unit (e.g., input circuitry, input module) 120, a touch screen 130, an audio processor 140, a memory 150, an interface 160, a camera module 170, a controller 180, and a power supply module 190. The elements of the electronic device 100 shown in FIG. 1 are not essential in various exemplary embodiments of the present disclosure and thus the electronic device may include more elements or fewer element than the elements shown in FIG. 1.

The wireless communication unit 110 may include one or more modules enabling wireless communication between the electronic device 100 and another external electronic device. According to various exemplary embodiments, the wireless communication unit 110 may include a module (for example, a short-range communication module, a long-range communication module, or the like) for communicating with neighbor external electronic devices. For example, the wireless communication unit 110 may include a mobile communication module 111, a wireless local area network (LAN) module 113, a short-range communication module 115, and a location calculation module 117.

The mobile communication module 111 may exchange radio signals with at least one of a base station, an external electronic device, and various servers (for example, an integration server, a provider server, a content server, an Internet server, or a cloud server) on a mobile communication network. The radio signals may include voice signals, data signals, or control signals of various formats. The mobile communication module 111 may transmit various data required to operate the electronic device 100 to an external device (for example, a server or another electronic device) in response to a user request. According to various exemplary embodiments, the mobile communication module 111 may exchange radio signals based on various communication methods. For example, the communication methods may include, but not limited to, long term evolution (LTE), LTE-Advanced (LTE-A), global system for mobile communication (GSM), enhanced data GSM environment (EDGE), code division multiple access (CDMA), wideband CDMA (WCDMA), universal mobile telecommunications system (UMTS), or orthogonal frequency division multiple access (OFDMA).

The wireless LAN module 113 may indicate a module for wirelessly connecting to the Internet and forming a wireless LAN link with other external electronic devices. The wireless LAN module 113 may be embedded in the electronic device 100 or may be provided outside the electronic device 100. The wireless Internet technology may use wireless fidelity (WiFi), wireless broadband (Wibro), world interoperability for microwave access (WiMax), high speed downlink packet access (HSDPA), or millimeter wave (mmWave), or the like. The wireless LAN module 113 may interwork with another external electronic device connected with the electronic device 100 via a network (for example, a wireless Internet network) to transmit various data of the electronic device 100 to the outside (for example, an external electronic device or a server) or to receive data from the outside. The wireless LAN module 113 may maintain an on state or may be turned on according to settings of the electronic device 100 or a user input.

The short-range communication module 115 may indicate a module for performing short-range communication. The short-range communication technology may use Bluetooth, Bluetooth low energy (BLE), radio frequency identification (RFID), infrared data association (IrDA), ultra wideband (UWB), Zigbee, near field communication (NFC), or the like. The short-range communication module 115 may interwork with another external electronic device (for example, an external audio device) connected with the electronic device 100 via a network (for example, a short-range communication network) to transmit various data of the electronic device 100 to an external electronic device or receive data therefrom. The short-range communication module 115 may maintain an on state or may be turned on according to settings of the electronic device 100 or a user input.

The location calculation module 117 is a module for acquiring a location of the electronic device 100 and may include, for example, a global positioning system (GPS). The location calculation module 117 may measure the location of the electronic device 100 according to the principle of triangulation. For example, the location calculation module 117 may calculate distance information on distances from three or more base stations and time information and then may calculate current location information of three dimensions according to a latitude, a longitude, and an altitude by applying triangulation to the calculated information. Alternatively, the location calculation module 117 may calculate location information by continuously receiving the location information of the electronic device 100 from three or more satellites in real time. The location information of the electronic device 100 may be acquired in various methods.

The user input unit 120 may generate input data for controlling the operation of the electronic device 100 in response to a user input. The user input unit 120 may include at least one inputting means for detecting user's various inputs. For example, the user input unit 120 may include a key pad, a dome switch, a physical button, a touch (capacitive/resistive), a jog & shuttle, and a sensor. According to one embodiment, the user input unit 120 may include an electronic pen (or a pen). According to one embodiment, the user input unit 120 may be implemented to receive an input of a force touch. The user input unit 120 may have a part thereof formed on the outside of the electronic device 100 in the form of a button, and a part or entirety of the user input unit 120 may be implemented as a touch panel. The user input unit 120 may receive a user input for initiating the operation of the electronic device 100 according to various exemplary embodiments of the present disclosure, and may generate an input signal according to a user input.

The touch screen 130 may indicate an input and output device performing an input function and a display function simultaneously, and may include a display 131 and a touch sensor 133. The touch screen 130 may provide an input and output interface between the electronic device 100 and the user, may transmit a user's touch input to the electronic device 100, and may serve as a medium to show an output from the electronic device 100 to the user. The touch screen 130 may show a visual output to the user. The visual output may be displayed in the form of a text, a graphic, a video and a combination thereof. According to an exemplary embodiment of the present disclosure, the touch screen 130 may display various screens according to operations of the electronic device 100 through the display 131. The touch screen 130 may detect an event (for example, a touch event, an approach event, a hovering event, or an air gesture event) based on at least one of a touch, hovering, or an air gesture from the user through the touch sensor 133, while displaying a specific screen through the display 131, and may transmit an input signal according to the event to the controller 180.

According to various exemplary embodiments of the present disclosure, the display 131 may display (output) a variety of information processed in the electronic device 100. For example, the display 131 may display a user interface (UI) or a graphic user interface (GUI) which is related to: an operation of displaying a first user interface for writing a note on the display when a note event is detected in a screen off state; and an operation of displaying a second user interface related to the note when an object for fixed display included in the first user interface is selected.

The display 131 may support a screen display according to a landscape mode, a screen display according to a portrait mode, or a screen display according to a change between the landscape mode and the portrait mode according to a rotation direction (or a laying direction) of the electronic device 100. The display 131 may use various displays. According to various exemplary embodiments, the display 131 may use a bended display. For example, the display 131 may include a bended display which can be bended, crooked, or rolled without being damaged through a substrate which is thin or flexible like paper.

The bended display may be secured to a housing (for example, a main body) and may maintain a bended state. According to various exemplary embodiments, the electronic device 100 may be implemented by using a display device which can be freely bended or unbended like a flexible display in addition to the bended display. According to various exemplary embodiments, the display 131 may give flexibility to be able to be folded and unfolded by substituting a glass substrate enclosing liquid crystals with a plastic film in a liquid crystal display (LCD), a light emitting diode (LED) display, an organic LED (OLED) display, an active matrix OLED (AMOLED) display, or electronic paper. According to various exemplary embodiments, the display 131 may be extended to at least one side (at least one of a left side, a right side, an upper side, and a lower side) of the electronic device 100.

The touch sensor 133 may be seated in the display 131 and may detect a user input contacting or approaching the surface of the touch screen 130. According to an exemplary embodiment of the present disclosure, the touch sensor 133 may receive a user input for initiating an operation related to the use of the electronic device 100 and may generate an input signal according to a user input. The user input may include a touch event or an approach event which is inputted based on at least one of a single touch, a multi-touch, hovering, or an air gesture. For example, the user input may be inputted in a method of a tap, a drag, a sweep, a swipe, a flick, a drag & drop, or a drawing gesture (for example, hand writing or the like).

The audio processor 140 may transmit an audio signal which is received from the controller 180 to a speaker 141, and may transmit an audio signal which is received from a microphone 143, such as a voice, to the controller 180. The audio processor 140 may convert voice/sound data into an audible sound and output the audible sound through the speaker 141 under the control of the controller 180, and may convert an audio signal received from the microphone 143 such as a voice into a digital signal and may transmit the digital signal to the controller 180. The audio processor 140 may output an audio signal which responds to a user input according to audio processing information (for example, a sound effect, a music file, or the like) inserted into data.

The speaker 141 may output audio data which is received from the wireless communication unit 110 or stored in the memory 150. The speaker 141 may output audio signal related to various operations (functions) performed in the electronic device 100. Although they are not shown in the embodiment of the present disclosure, the speaker 141 may have an attachable and detachable ear phone, a head phone, or a head set connected to the electronic device 100 through an external port.

The microphone 143 may receive an external audio signal and process it to electric voice data. Various noise reduction algorithms may be implemented to reduce a noise occurring in the process of the microphone 143 receiving the external audio signal. The microphone 143 may serve to input an audio stream such as a voice command (for example, a voice command for initiating a music application operation). The microphone 143 may include an internal microphone mounted in the electronic device 100 and an external microphone connected to the electronic device.

The memory 150 may store one or more programs executed by the controller 180, and may perform a function of temporarily storing inputted/outputted data. The inputted/outputted data may include files such as videos, images, photos, audios, or the like. The memory 150 may serve to store acquired data and data acquired in real time may be stored in a temporary storage device or data which is determined to be stored may be stored in a storage device which can store data for a long time.

The memory 150 may store instructions to detect a note event in a screen off state, to display a first user interface for writing a note on the display, to receive a note writing input from a user, and to display a second user interface related to the note when an object for fixed display included in the first user interface is selected. According to various exemplary embodiments, when being executed, the memory 150 may store instructions that cause the controller 180 (for example, one or more processors) to detect a note event in a screen off state, display a first user interface for writing a note on the display, receive a note writing input from a user, and display a second user interface related to the note when an object for fixed display included in the first user interface is selected.

The memory 150 may continuously or temporarily store an operating system (OS) of the electronic device 100, a program related to control of an input and a display using the touch screen 130, a program related to control of various operations (functions) of the electronic device 100, and various data generated by the operation of each program.

The memory 150 may include an extended memory (for example, an external memory) or an internal memory. The memory 150 may include a memory such as a flash memory type memory, a hard disk type memory, a micro type memory, and a card type memory (for example, a secure digital (SD) card or an eXtream digital (XD) card, and at least one type of storage medium from among a dynamic random access memory (DRAM), a static RAM (SRAM), a read only memory (ROM), a programmable ROM (PROM), an electrically erasable PROM (EEPROM), and a magnetic RAM (MRAM), a magnetic disk, and an optical disk. The electronic device 100 may operate in relation to a web storage which performs a storing function of the memory 150 on the Internet.

The memory 150 may store a variety of software. For example, the software element may include an operating system software module, a communication software module, a graphic software module, a user interface software module, a moving picture experts group (MPEG) module, a camera software module, one or more application software modules. In addition, since a module which is a software element may be expressed by a set of instructions, the module may be referred to as an instruction set. The module may also be referred to as a program.

The OS software module may include various software elements for controlling a normal system operation. Controlling the normal system operation may mean, for example, managing and controlling a memory, controlling and managing power, or the like. In addition, the OS software module may perform a function of smoothly communicating between various hardware (devices) and software elements (modules). The communication software module enables communication with another electronic device such as a computer, a server, or a mobile terminal through the wireless communication unit 110. In addition, the communication software module may be formed of a protocol structure corresponding to a corresponding communication method.

The graphic software module may include various software elements for providing and displaying graphics on the touch screen 130. The term “graphics” may be used to mean a text, a web page, an icon, a digital image, a video, an animation, or the like. The graphic software module may include various software elements related to a user interface. For example, the graphic software module may include information regarding how the state of a user interface is changed or in what condition the state of the user interface is changed.

The MPEG module may include a software element enabling a process and functions (for example, functions of generating, reproducing, distributing, and transmitting a content, or the like) related to a digital content (for example, a video, an audio). The camera software module may include a camera-related software element enabling a process and functions related to a camera.

The application module may include a web browser including a rendering engine, an email, an instant message, word processing, keyboard emulation, an address book, a widget, digital right management (DRM), iris scan, context cognition, voice recognition, a location-based service, or the like. According to various exemplary embodiments, the application module may process operations (functions) of displaying a representative color of a selected cell while outputting a sound sample corresponding to the selected cell, and displaying a trace effect on a region between two cells.

The interface 160 may receive data from another external electronic device or may be supplied with power and transmit power to the respective elements of the electronic device 100.

The interface 160 may transmit internal data of the electronic device 100 to another external electronic device. For example, a wire/wireless headphone port, an external charger port, a wire/wireless data port, a memory card port, an audio input/output port, a video input/output port, an earphone port, or the like may be included in the interface 160.

The camera module 170 may indicate an element supporting a photographing function of the electronic device 100. The camera module 170 may photograph a certain subject under the control of the controller 180 and transmit photographed data (for example, an image) to the display 131 and the controller 180. The camera module 170 may include one or more image sensors. For example, the camera module 170 may include a front sensor (for example, a front camera) provided on the front surface (for example, a surface which is coplanar with the display 131) and a rear sensor (for example, a rear camera) provided on the rear surface (for example, a bottom surface) of the electronic device 100.

The controller 180 may control an overall operation of the electronic device 100. For example, the controller 180 may perform various control operations related to music play, voice communication, data communication video communication, or the like. The controller 180 may be implemented by using one or more processors or the controller 180 may be referred to as a processor. For example, the controller 180 may include a communication processor (CP), an application processor (AP), an interface (for example, a general purpose input/output (GPIO)), or an internal memory as separate elements, or may integrate them into one or more integrated circuits. The AP may perform various functions for the electronic device 100 by executing various software programs, and the CP may process and control voice communication and data communication. In addition, the controller 180 may execute a specific software module (an instruction set) stored in the memory 150 and perform various specific functions corresponding to the module.

According to various exemplary embodiments, the controller 180 may process operations of: detecting a note event in a screen off state; displaying a first user interface for writing a note on the display 131; receiving a note writing input from a user; and, when an object for fixed display included in the first user interface is selected, displaying a second user interface related to the note. The control operations of the controller 180 according to various exemplary embodiments of the present disclosure will be described below with reference to the accompanying drawings.

According to various exemplary embodiments, the controller 180 may control various operations related to normal functions of the electronic device 100 in addition to the above-described functions. For example, when a specific application is executed, the controller 180 may control a management of the application and a screen display. In addition, the controller 180 may receive an input signal corresponding to various touch event or approach event inputs supported by a touch-based or approach-based input interface (for example, the touch screen 130), and may control a function management according to the input signal. In addition, the controller 180 may control exchange of various data based on wire communication or wireless communication.

The power supply module 190 may be supplied with external power or internal power under the control of the controller 180, and may supply power required to perform operations of the respective elements. According to an exemplary embodiment of the present disclosure, the power supply module 190 may supply power or shut off the power supply to the display 131, the camera module 170, or the like under the control of the controller 180.

In addition, in some cases, embodiments described in the present specification may be implemented by the controller 180. In addition, according to software-based implementation, embodiments such as procedures and functions described in the present specification may be implemented by using separate software modules. Each of the software modules may perform one or more functions and operations described in the present specification

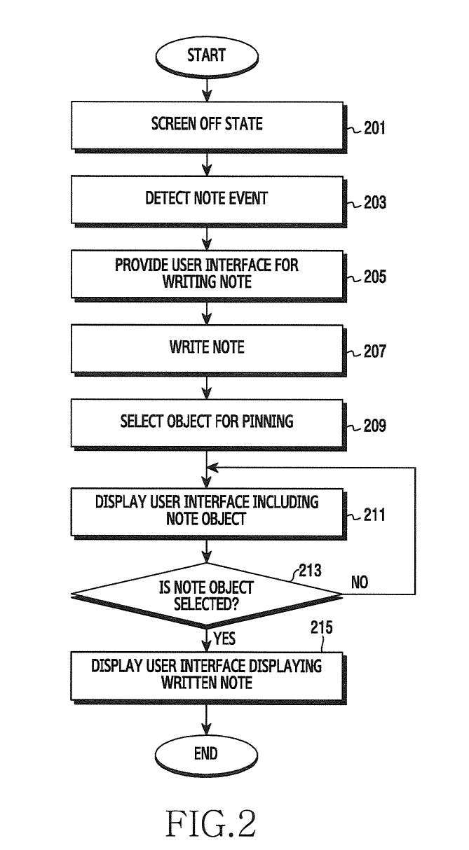

FIG. 2 is a flowchart showing a method for operating of an electronic device according to various exemplary embodiments.

Referring to FIG. 2, in operation 201, the electronic device (for example, the controller 180) may be in a screen off state. The screen off state may refer to an off state of the display 131 of the electronic device 100. However, the screen off state may include a state in which the display 131 is turned off according to settings of the electronic device 100 and information is not displayed, or a state in which the display 131 is operated in a low power mode (or a power saving mode) and set information is displayed (for example, always on display). For example, when a user input is not received during a predetermined time after the power of the display 131 is turned on, the controller 180 may turn off the power of the display 131. Alternatively, when a display off command (for example, selecting a power button (or a locking button)) is received from a user, the controller 180 may turn off the power of the display 131. When the power of the display 131 is turned off, the controller 180 may switch to a state in which the display 131 is turned off and nothing is displayed, or a state in which the display 131 is operated in a low power mode and only some region is activated.

For example, when the power of the display 131 is turned off, a display region of the display 131 may be changed to black and nothing may be displayed on the display 131. Alternatively, the display region of the display 131 may be changed to a dark color (for example, black) and set information (for example, a date, clock, a battery state, or the like) may be displayed on some region of the display region. For example, though the controller 180 activates some region of the display 131 and displays the set information thereon, the controller 180 may maintain the background color of some region in black and display the set information in a bright color (for example, white). That is, when the power of the display 131 is turned off and the display 131 is driven in a low power mode, the display region of the display 131 may be maintained in black and only the set information may be displayed in a color (for example, white) contrasting with black.

According to various exemplary embodiments, the controller 180 may fix a location for displaying the set information or may change the location periodically or in real time (for example, to the top, bottom, left, or right). Changing the display location of the set information may be to prevent a burn-in phenomenon. The burn-in phenomenon refers to a phenomenon in which, when a fixed screen is displayed on the electronic device 100 for a long time or a same image is repeated, the corresponding image does not disappear and remains on the screen. Accordingly, when the background of the display 131 is maintained in black and only the set information is displayed in white, the controller 180 may change the display location of the set information in order to overcome the disadvantage of an after image or a blur on the display 131. Alternatively, the controller 180 may fix the location for displaying the set information.

Hereinafter, the screen off state described in the present disclosure may refer to a state in which the display 131 is turned off and information is not displayed or a state in which the display 131 is operated in a low power mode and set information is displayed.

In operation 203, the electronic device (for example, the controller 180) may detect a note event. The note (or memo) event may include an input of separating an electronic pen provided in the electronic device 100 or a predetermined touch input (for example, a gesture of tapping the display 131). For example, the gesture of tapping the display 131 may be an operation of continuously tapping the display 131 two or more times. According to various exemplary embodiments, the note event may be distinguished from a display on event. The display on event (or screen on event) may refer to selecting, by a user, a power button or a home button.

For example, when the note event is detected, the controller 180 may operate the display 131 in a low power mode and may maintain the display region of the display 131 in black.

However, when the display on event is detected, the controller 180 may supply power to the display 131 and may switch the display 131 to a driving mode. When the display 131 is switched to the driving mode, the display region of the display 131 may not be maintained in black and may display a set user interface screen. For example, the user interface screen may include at least one of a lock screen (for example, a background image, a date, time, or the like), a home screen or an application execution screen. That is, the display region of the display 131 may be changed from black to the user interface display screen (for example, a color for displaying the user interface).

In operation 205, the electronic device (for example, the controller 180) may provide a user interface for writing a note (or a memo). The controller 180 may maintain the background of the display 131 in black and may display a user interface for writing a note. For example, the electronic device 100 may include a first layer for displaying the background of the display 131 in black and a second layer for displaying the user interface for writing the note. The first layer may correspond to the second layer and the second layer may be superimposed on the first layer.

For example, the user interface for writing the note may include at least one of an input field, a pen change object, an eraser object, a delete object, a save object, or an object for fixed display. The input field may be a region for receiving an input of a note from the user. The pen change object may be an icon for changing a letter style (or font), a font-weight, a size, a color, or the like of a pen. The eraser object may be an icon for removing (correcting) a part of the note inputted (or written) to the input field. The delete object may be an icon for deleting the note inputted to the input field. The save object may be an icon for saving the note inputted to the input field in the memory 150. The object for fixed display may be an icon for setting the note inputted to the input field to be maintained in the screen off state. In operation 207, the electronic device (for example, the controller 180) may write a note based on a user input. The controller 180 may write a note based on a user input of selecting various objects included in the user interface for writing the note. For example, the controller 180 may receive an input of a text (for example, a character, a number, a sign, a picture, or the like) to the input field through the electronic pen or a user's body (for example, a finger). In addition, after inputting the text to the input field, the controller 180 may receive selection of at least one of the pen change object, the eraser object, the delete object, the save object, and the object for fixed display.

According to various exemplary embodiments, the user interface for writing the note may further include a camera object. The camera object may be an icon for driving a camera. The user may take a photograph (or an image) by driving the camera (for example, by executing a camera application) using the camera object. When the camera object is selected, the controller 180 may drive the camera. According to various exemplary embodiments, the controller 180 may switch to the screen on state when the camera is driven and may convert the mode of the display 131 to the driving mode. When a photograph is taken (for example, a photographing button is selected), the controller 180 may display the object for fixed display. When the object for fixed display is selected, the controller 180 may store the photographed in the memory 150. The controller 180 may set the photographed image as a screen off background. According to various exemplary embodiments, the controller 180 may reduce the original size of the photographed image by a predetermined ratio (for example, 80%, 70%, or the like) and set the image as the screen off background. According to various exemplary embodiments, the controller 180 may change the photographed image and set the image as the screen off background. For example, the controller 180 may change the color of the image (for example, to a dark color (for example, black)). The memory 150 may store the original of the photographed image or the changed image.

In operation 209, the electronic device (for example, the controller 180) may detect selection of the object for fixed display. When the selection of the object for fixed display is detected, the controller 180 may convert the note input to the input field into an image and store the converted image in the memory 150. According to various exemplary embodiments, the controller 180 may reduce the original size of the note by a predetermined ratio (for example, 80%, 70%, or the like) when converting the note into the image. According to various exemplary embodiments, the controller 180 may store the original note in the memory 150 with the converted image. Storing the image in the memory 150 with the original note may be to edit the note. In addition, the controller 180 may generate a note object informing that there is a note written in the screen off state.

In operation 211, the electronic device (for example, the controller 180) may display a user interface including a note object. The note object may be an icon informing that there is a note written in the screen off state. When the object for fixed display is selected, the controller 180 may convert the user interface for writing the note into the user interface including the note object. The user interface including the note object may be a user interface which displays the note object when displaying the set information in the screen off state in operation 201. For example, at least one of a date, time, a battery state, and an application object (for example, an application-related icon) may be displayed as the set information in the screen off state. The user interface including the note object may be a user interface which displays the note object with the set information.

In operation 213, the electronic device (for example, the controller 180) may detect whether the note object is selected or not. The controller 180 may detect whether a touch input (for example, a selection input) from the user occurs on the note object. When the note object is selected, the controller 180 may perform operation 215, and, when the note object is not selected, the controller 180 may maintain operation 211. According to various exemplary embodiments, when the display 131 is driven in the low power mode in the screen off state and the set information is displayed, and the note object is not selected, the electronic device (for example, the controller 180) may continue displaying the user interface including the note object.

According to various exemplary embodiments, when a user input such as a single tap, a double tap, or a long press is detected on the note object, the electronic device (for example, the controller 180) may determine that the note object is selected. Alternatively, in order to prevent malfunction, the controller 180 may determine that the note object is not selected when a user input such as a single tap is detected, and may determine that the note object is selected when a user input such as a double tap or a long press is detected.

When the note object is selected, the electronic device (for example, the controller 180) may display a user interface displaying the written note in operation 215. The user interface displaying the written note may be distinguished from the user interface including the note object. For example, when the display 131 is driven in the low power mode in the screen off state and the set information is displayed, the user interface displaying the written note may be a user interface which displays a content of the written note with the set information. According to various exemplary embodiments, the content of the written note may be displayed based on an image or a text. In addition, the user interface displaying the written note may include a note fold object and a note delete object. The content of the note according to various exemplary embodiments may be an image which is set as the screen off background. That is, the user interface displaying the written note may display the image which is set as the screen off background instead of the content of the note.

According to various exemplary embodiments, the controller 180 may display the user interface displaying the written note by adjusting the layout of the user interface including the note object. For example, the controller 180 may display the user interface displaying the written note by adjusting at least one of a content, a letter style, a font-weight, and a size of the set information displayed on the user interface including the note object. That is, the set information included in the user interface including the note object and the set information included in the user interface displaying the written note may be the same, similar, or different.

According to various exemplary embodiments, the note may be written and viewed in the screen off state. That is, the note can be written, viewed, or edited in the screen off state without executing a note application to write, view, or edit a note in the screen off state or without unlocking the electronic device as in a related-art method.

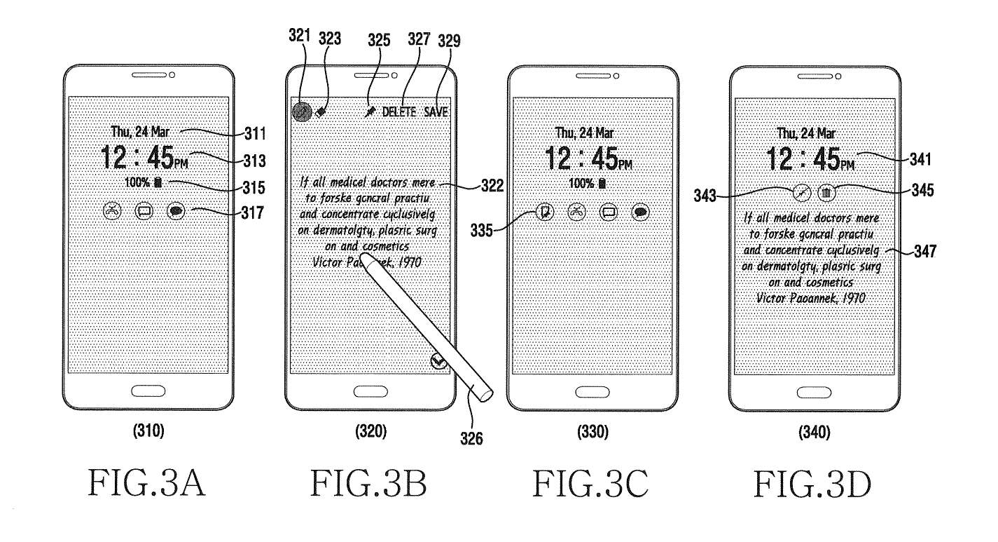

FIGS. 3A-3D are views showing examples of a user interface related to a note in a screen off state according to various exemplary embodiments.

The electronic device (for example, the controller 180) may display a first user interface 310 in a screen off state. The first user interface 310 may be a user interface which has the display 131 operated in a low power mode and displays set information. The background color of the first user interface 310 may be black and the color of the set information may be white. For example, the set information may include a date 311, time 313, a battery state 315, and an application object 317. The application object 317 may refer to an icon for executing an application.

According to various exemplary embodiments, when a note event is detected while the first user interface 310 is being displayed, the electronic device (for example, the controller 180) may display a second user interface 320. The note event may include an electronic pen 326 being separated from the electronic device 100 or a predetermined touch input. The second user interface 320 may be a user interface for writing a note. The second user interface 320 may include at least one of an input field 322, a pen change object 321, an eraser object 323, a delete object 327, a save object 329, or an object 325 for fixed display. According to various exemplary embodiments, the second user interface 320 may be formed of a first layer for displaying the background of the display 131 in black and a second layer for displaying a user interface for writing a note. The background color of the second user interface 320 may be black and at least one of the pen change object 321, the eraser object 323, the delete object 327, the save object 329, or the object 325 for fixed display may be displayed in white.

According to various exemplary embodiments, when a note is written on the second user interface 320 and then the object 325 for fixed display is selected, the electronic device (for example, the controller 180) may display a third user interface 330. The third user interface 330 may be a user interface including a note object 335. The third user interface 330 may be the first user interface 310 to which the note object 335 is added. That is, the third user interface 330 may include the date (Thu 24 March), the time (12:45 pm), the battery state (100%), and the application object. The application object may include the note object 335 and an icon for executing an application.

According to various exemplary embodiments, when the note object 335 is selected while the third user interface 330 is being displayed, the electronic device (for example, the controller 180) may display a fourth user interface 340. The fourth user interface 340 may be a user interface displaying the written note. The fourth user interface 340 may be a user interface which displays a note content 347 with the set information 341. In addition, the fourth user interface 340 may include a note fold object 343 and a note delete object 345. The note fold object 343 may be an icon for making the displayed note hidden (for example, disappear). The note delete object 345 may be an icon for deleting the displayed note. According to various exemplary embodiments, the note content 347 may be an image which is photographed by the camera.

According to various exemplary embodiments, when the note fold object 343 is selected (touched) by the user, the electronic device (for example, the controller 180) may convert from the fourth user interface 340 into the third user interface 330. That is, when the note fold object 343 is selected, the controller 180 may display the third user interface 330 which does not display the content of the note and includes the note object 335 informing that there is a written note. According to various exemplary embodiments, when the note delete object 345 is selected by the user, the electronic device (for example, the controller 180) may convert from the fourth user interface 340 into the first user interface 310. That is, when the note delete object 345 is selected, the controller 180 may delete the displayed note and display the first user interface 310.

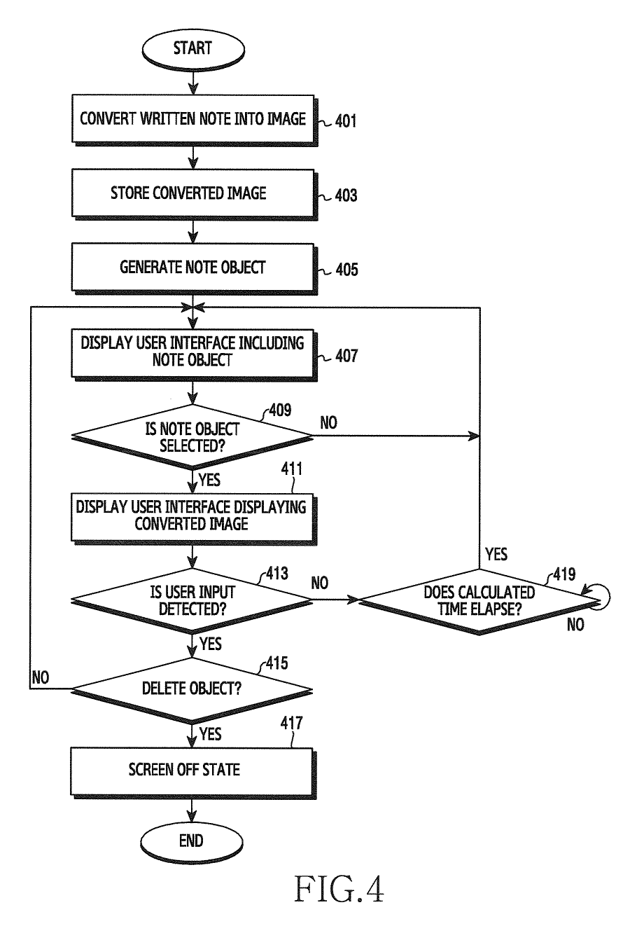

FIG. 4 is a flowchart showing a method for providing a user interface related to a note in an electronic device according to various exemplary embodiments. FIG. 4 is a flowchart showing operations after operation 209 of FIG. 2 in detail.

Referring to FIG. 4, in operation 401, the electronic device (for example, the controller 180) may convert the written note into an image. When the selection of the object for fixed display is detected, the controller 180 may convert the inputted (written) note into an image. According to various exemplary embodiments, the controller 180 may reduce the original size of the note by a predetermined ratio (for example, 80%, 70%, or the like) when converting the note into the image. According to various exemplary embodiments, the controller 180 may determine whether to adjust the size of the note based on the size of the written note. For example, when the size of the written note is large (for example, the size of the note is greater than or equal to a reference size), the controller 180 may adjust the size of the note when converting the note into the image, and, when the size of the written note is small (for example, the size of the note is less than the reference size), the controller 180 may not adjust the size of the note when converting the note into the image. The reference size for determining whether to adjust the size may be determined according to user's settings, the size of the display 131, and settings of the electronic device 100.

In operation 403, the electronic device (for example, the controller 180) may store the converted image in the memory 150. According to various exemplary embodiments, the controller 180 may store the original note in the memory 150 with the converted image. Storing the original note in the memory 150 may be to edit the note. According to various exemplary embodiments, the controller 180 may relate the converted image to an image application (or a gallery application) and store the image. That is, the converted image may be displayed with other images when the gallery application is executed. The controller 180 may relate the original note to a note application and store the original note. That is, the original note may be included in a note list when the note application is executed.

In operation 405, the electronic device (for example, the controller 180 may generate a note object related to the written note. The note object may be an icon for informing that there is a note written in the screen off state.

In operation 407, the electronic device (for example, the controller 180) may display a user interface including the note object. The user interface including the note object may be the third user interface 330 of FIG. 3C. The user interface including the note object has been described and thus a detailed description thereof is omitted here.

In operation 409, the electronic device (for example, the controller 180) may detect whether the note object is selected or not. The controller 180 may detect whether a touch input (for example, a selection input) from the user occurs on the note object. When the note object is selected, the controller 180 may perform operation 411, and, when the note object is not selected, the controller 180 may maintain operation 407. According to various exemplary embodiments, when the note object is not selected, the electronic device (for example, the controller 180) may continue displaying the user interface including the note object.

When the note object is selected, the electronic device (for example, the controller 180) may display a user interface displaying the converted image in operation 411. The user interface displaying the converted image may be the same as or similar to the user interface displaying the written note described in operation 215 of FIG. 2. The user interface displaying the converted image may include at least one of the set information displayed in the screen off state, an image displaying the content of the written note, a note fold object, and a note delete object. The user interface displaying the converted image may be the fourth user interface 340 of FIG. 3D. The user interface displaying the converted image has been described and thus a detailed description thereof is omitted here.

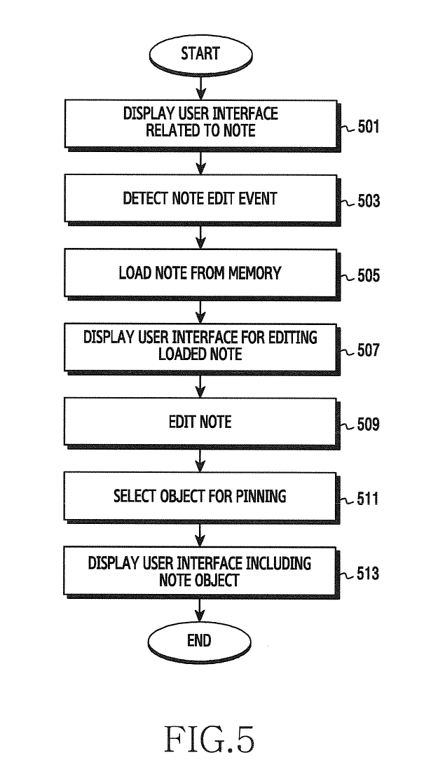

In operation 413, the electronic device (for example, the controller 180) may determine whether a user input is detected or not. The user input may refer to a touch input occurring on the note fold object or the note delete object. For example, when the touch input occurs on any one of the note fold object or the note delete object, the electronic device may perform operation 415. According to various exemplary embodiments, when a touch input occurs on the converted image, the controller 180 may perform a note edit process. For example, when a user input such as a double tap or a long press is detected on the converted image, the controller 180 may determine that a note edit event occurs. When the note edit event is detected, the controller 180 may perform the note edit process. The note edit process will be described below with reference to FIG. 5.

When the user input is detected, the controller 180 may perform operation 415, and, when the user input is not detected, the controller 180 may perform operation 419. According to various exemplary embodiments, when a touch occurs on a location other than the converted image, the note fold object, or the note delete object, the controller 180 may determine that the user input is not detected. According to various exemplary embodiment, when a predetermined touch input (for example, a double tap, a long press) is detected on the set information, the controller 180 may perform a process to change the set information (for example, to change a nation, a date, or time) or change the state of the display (for example, to change brightness, a color, a display holding time, or display settings).

When the user input is not detected, the electronic device (for example, the controller 180) may determine whether a selected (or predetermined) time elapses or not in operation 419. For example, the controller 180 may determine whether a time which has elapsed from the time when the user interface displaying the converted image was displayed to a current time exceeds a selected time (for example, 30 minutes, 1 hour, or the like). The controller 180 may display the user interface displaying the converted image during the selected time. The controller 180 may display the user interface including the note object after the selected time.

That is, when the user input is not detected and the time which has elapsed from the time when the user interface displaying the converted image was displayed to the current time does not exceed the selected time, the controller 180 may continue displaying the user interface displaying the converted image. Alternatively, when the user input is not detected and the time which has elapsed from the time when the user interface displaying the converted image was displayed to the current time exceeds the selected time, the controller 180 may convert from the user interface displaying the converted image into the user interface including the note object.

When the user input is detected, the electronic device (for example, the controller 180) may determine whether the delete object is selected or not in operation 415. According to various exemplary embodiments, the controller 180 may perform operation 417 or operation 407 according to whether the user input occurs on at least one of the note fold object or the note delete object. For example, when the delete object is selected, the controller 180 may perform operation 417, and, when the delete object is not selected, the controller 180 may return to operation 407.

According to various exemplary embodiments, when the user input is detected but the detected user input is not the delete object, the controller 180 may determine that the note fold object is selected. In this case, the controller 180 may display the user interface including the note object. For example, when the note fold object is selected in the user interface displaying the converted image, the controller 180 may convert from the user interface displaying the converted image into the user interface including the note object. The user interface including the note object may be the third user interface 330 of FIG. 3C.

When the delete object is selected, the electronic device (for example, the controller 180) may switch to the screen off state in operation 417. For example, when the note delete object is selected in the user interface displaying the converted image, the controller 180 may switch to the screen off state. The controller 180 may turn off the display 131 and may not display information by performing operation 201 of FIG. 2, or may operate the display 131 in a low power mode (or a power saving mode) and display the set information. The user interface displaying the set information may be the first user interface 310 of FIG. 3A.

FIG. 5 is a flowchart showing a method for providing a user interface related to a note edit in an electronic device according to various exemplary embodiments.

Referring to FIG. 5, in operation 501, the electronic device (for example, the controller 180) may display a user interface related to a note. The user interface related to the note may include a user interface including a note object (for example, the third user interface 330 of FIG. 3C), and a user interface displaying a written note (for example, the fourth user interface 340 of FIG. 3D).

In operation 503, the electronic device (for example, the controller 180) may detect a note edit event. The note edit event may include an input of separating an electronic pen provided in the electronic device 100 or a predetermined touch input. According to various exemplary embodiments, the note edit event may be the same as or different from the above-described note event. For example, the note edit event may be an input of separating the electronic pen provided in the electronic device 100 in the state in which the user interface related to the note is displayed.

Alternatively, the note edit event may be a touch input occurring on the written note in the state in which the user interface displaying the written note is displayed. For example, when a user input such as a double tap or a long press is detected on the written note, the controller 180 may determine that the note edit event occurs. The user input such as the double tap or the long press on the written note may correspond to the predetermined touch input.

In operation 505, the electronic device (for example, the controller 180) may load the note from the memory 150. The controller 180 may load the original note from the memory 150 to edit the note. The original note is based on a text and a part or entirety of a content of the original note may be edited. According to various exemplary embodiments, the controller 180 may load the note written in the screen off state from the memory 150. For example, when only one note could be written in the screen off state, the controller 180 may load the one note written in the screen off state from the memory 150.

According to various exemplary embodiments, the controller 180 may load the most recently written note from the memory 150. The most recently written note may be a note which has been written in the screen off state or a note which has not been written in the screen off state. For example, the note which has not been written in the screen off state may be a note which has been written in the screen on state or has been set as a screen off background. In this case, the original note may not be based on the text. That is, when the note that the user sets as the screen off background in the screen on state is the image, the original note may be the image.

In operation 507, the electronic device (for example, the controller 180) may display a user interface for editing the loaded note. The user interface for editing the note may include the loaded original note in an input field, and may include at least one of a pen change object, an eraser object, a delete object, a save object, or an object for fixed display. The user interface for editing the note according to various exemplary embodiments may be the same as or similar to the user interface for writing the note as shown in FIG. 2 (for example, the second user interface 320 of FIG. 3B). This is because, when the user interface for writing the note is displayed for the first time, nothing is inputted to the input field and the input field is empty. However, when the user interface for editing the note is displayed for the first time, the input field may include the content of the note loaded from the memory 150.

Accordingly, the user interface for editing the note and the user interface for writing the note may be different from each other in their input fields, and may be the same as or similar to each other in their function (or function control) menus such as the pen change object, the eraser object, the delete object, the save object, or the object for fixed display. Alternatively, the user interface for editing the note may not include at least one of the pen change object, the eraser object, the delete object, the save object, or the object for fixed display. For example, the user interface for editing the note may not include the save object or the delete object.

In operation 509, the electronic device (for example, the controller 180) may edit the note. For example, the controller 180 may change a letter style, a font-weight, or the like of the loaded note using the pen change object based on a user input. The controller 180 may remove (correct) an entirety or a part of the loaded note using the eraser object. The controller 180 may delete the loaded note using the delete object. The controller 180 may save the loaded note in the memory 150 using the save object. The controller 180 may set the loaded note to be maintained in the screen off state using the object for fixed display.

According to various exemplary embodiments, the user interface for editing the note may further include a camera object. When the camera object is selected, the controller 180 may drive a camera and photograph based on a user input. When a photograph is taken (for example, a photographing button is selected), the controller 180 may display the object for fixed display. When the object for fixed display is selected, the controller 180 may store the photographed image in the memory 150. The controller 180 may set the photographed image as a screen off background. That is, the controller 180 may set the photographed image as the screen off background instead of the loaded image. According to various exemplary embodiments, the controller 180 may reduce the size of the photographed image or change the color of the image, and may set the changed image as the screen off background.

In operation 511, the electronic device (for example, the controller 180) may detect selection of the object for fixed display. When the selection of the object for fixed display is detected, the controller 180 may convert the note inputted to the input field into an image and store the converted image in the memory 150. In converting into the image, the controller 180 may reduce the original size of the note by a predetermined ratio (for example, 80%, 70%, or the like). Alternatively, when the note inputted to the input field is an image, the controller 180 may directly store the note in the memory 150 without converting into the image. Alternatively, when the note inputted to the input field is an image, the controller 180 may reduce the size of the image. In addition, after converting into the image or adjusting the size of the image, the controller 180 may generate a note object informing that there is a written note.

In operation 513, the electronic device (for example, the controller 180) may display a user interface including the note object. When the object for fixed display is selected, the controller 180 may convert the user interface for editing the note into the user interface including the note object (for example, the third user interface 330 of FIG. 3C).

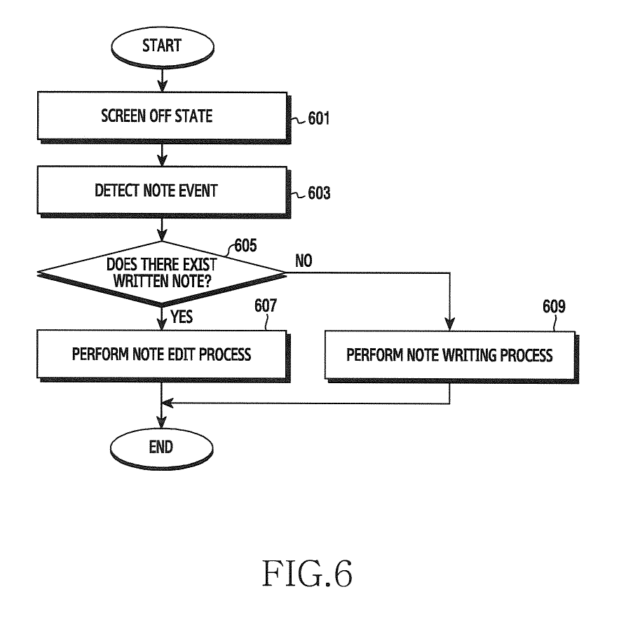

FIG. 6 is a flowchart showing a method for controlling a note of an electronic device according to various exemplary embodiments.

Referring to FIG. 6, in operation 601, the electronic device (for example, the controller 180) may be in a screen off state. In the screen off state, the display 131 may be turned off and information may not be displayed or the display 131 may be operated in a low power mode (or a power saving mode) and set information may be displayed. The screen off state has been described through the above-described drawings and thus a detailed description thereof is omitted.

In operation 603, the electronic device (for example, the controller 180) may detect a note event. The note event may include an input of separating an electronic pen provided in the electronic device 100 or a predetermined touch input (for example, a gesture of tapping the display 131).

In operation 605, the electronic device (for example, the controller 180) may determine whether there exists a written note. The controller 180 may determine whether a note written in the screen off state is stored in the memory 150. Alternatively, the controller 180 may determine whether there is a note set as a screen off background in a screen on state.

When there exists the written note, the controller 180 may perform operation 607, and, when there does not exist the written note, the controller 180 may perform operation 609.

In operation 609, the electronic device (for example, the controller 180) may perform a note writing process. For example, the note writing process may include an operation of providing a user interface for writing a note and an operation of writing a note based on a user input. That is, the note writing process may include operations 205 to 207 of FIG. 2.

In operation 607, the electronic device (for example, the controller 180) may perform a note edit process. For example, the note edit process may include an operation of loading a note from the memory, an operation of displaying a user interface for editing the loaded note, and an operation of editing the note based on a user input. That is, the note edit process may include operations 505 to 509 of FIG. 5.

According to various exemplary embodiments, the electronic device (for example, the controller 180) may easily write or edit the note according to a user's input in the screen off state.

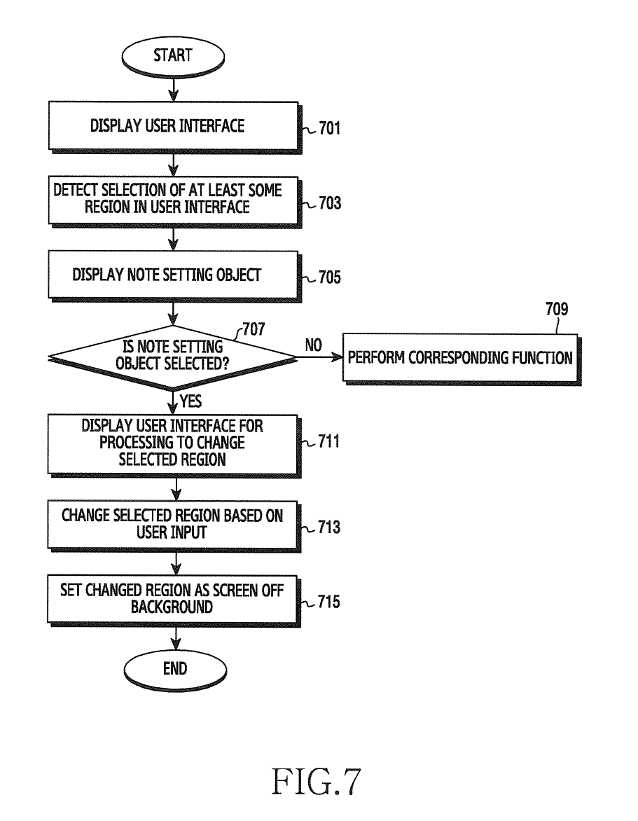

FIG. 7 is a flowchart showing a method for setting a screen off background of an electronic device according to various exemplary embodiments.

Referring to FIG. 7, in operation 701, the electronic device (for example, the controller 180) may display a user interface. The user interface may be an execution screen of an application. For example, the application may include a gallery application, a web application (for example, a search application or the like), a note application, or the like. That is, the user interface may be set as a background image or may be used to write a note.

In operation 703, the electronic device (for example, the controller 180) may detect selection of at least some region in the user interface. The at least some region may be selected by the user dragging at least one of a text, an image, and a video with an electronic pen or a finger, or selecting coordinates after a predetermined input. The predetermined input may be inputted before some region is selected, and for example, may be an input like a long press. For example, when a text is displayed on the user interface, the user may select all regions or some region by dragging a text (for example, a word, a sentence, or the like) that the user wishes to select (or by designating coordinates) after the predetermined input. When an image is displayed on the user interface, the user may select an entirety or a part of the image by dragging an image (for example, some region) that the user wishes to select (or by designating coordinates) after the predetermined input.

When a text and an image are displayed on the user interface, the user may select an entire region or some region by dragging a text and/or an image that the user wishes to select (or by designating coordinates) after the predetermined input. When a video is displayed on the user interface, the user may select an entire region or some region by dragging one frame (image) of the video (or by designating coordinates) after the predetermined input.

In operation 705, the electronic device (for example, the controller 180) may display a note setting object. When some region is selected, the controller 180 may provide a function menu including the note setting object. For example, the note setting object may be an icon for setting a selected region as a screen off background. According to various exemplary embodiments, the controller 180 may provide various function menu items for copying the selected region, selecting all regions, and sharing. That is, the function menu item may include at least one of the note setting object, a copy object, an all select object, or a share object.

In operation 707, the electronic device (for example, the controller 180) may determine whether the note setting object is selected or not. When the note setting object is selected, the controller 180 may perform operation 711, and, when the note setting object is not selected, the controller 180 may perform operation 709.

When the note setting object is not selected, the electronic device (for example, the controller 180) may perform a corresponding function in operation 709. For example, when the copy object is selected, the controller 180 may copy the selected region. When the all select object is selected, the controller 180 may select data (for example, a text, an image or a video) included in all regions of the user interface including the selected region. When the share object is selected, the controller 180 may provide a list of applications (for example, a message application, a messenger application, an email application, or the like) for sharing data (for example, a text, an image, or a video) included in the selected region with another user (for example, the other party)

In operation 711, the electronic device (for example, the controller 180) may display a user interface for processing to change the selected region. For example, the note setting object may be to set the selected region as a screen off background, and, since the display 131 is operated in a low power mode in the screen off state, the background of the display region may be displayed in black and displayed information may be displayed in white. Accordingly, the controller 180 may display a user interface for changing the background color of the selected region to black, and, when a text is included in the selected region, for changing the text to white.

According to various exemplary embodiments, the controller 180 may provide different user interfaces according to whether data included in the selected region is a text, an image, or a video. For example, when a text is included in the selected region, the controller 180 may display a user interface for processing to change the text. The user interface for processing to change the text may include a function menu item (or object) for changing at least one of a background color, a text color, a text size, and a letter style (or a font). When an image (or a video) is included in the selected region, the controller 180 may display a user interface for processing to change the image (or video). The user interface for processing to change the image (or video) may include a function menu item for reversing the color of the image (or video).

In operation 713, the electronic device (for example, the controller 180) may change the selected region based on a user input. According to various exemplary embodiments, the controller 180 may change at least one of the color, the size, the letter style (or font), and the background color of the text according to the user input in the user interface for processing to change the text. According to various exemplary embodiments, the controller 180 may reverse the color of the image (for example, change to a dark color (for example, black)) according to the user input in the user interface for processing to change the image (video). Alternatively, the controller 180 may reverse the color of the text included in the image and the background color each other according to the user input in the user interface for processing to change the image (video). For example, the controller 180 may change the color of the text included in the image to white, and may change the background color of the image to black.

In operation 715, the electronic device (for example, the controller 180) may set the changed region as the screen off background. When the screen off background is set, the controller 180 may display the changed region and the set information (for example, a date, time, a battery state) in the screen off state.

According to various exemplary embodiments, the controller 180 may photograph by executing a camera application. When the photograph is taken (for example, a photographing button is selected), the controller 180 may display the note setting object in a user interface including the taken photograph. Alternatively, when a certain image is selected from the gallery application, the controller 180 may display the note setting object in a user interface including the selected image. Alternatively, when an image edit is completed in an image edit application, the controller 180 may display the note setting object in a user interface including the edited image.

According to various exemplary embodiments, the controller 180 may detect a user input of selecting some region of the image (for example, the photographed, selected, or edited image) in the user interface, and select some region of the image based on a user input.

The user may select all regions or some region by dragging an image that the user wishes to select (or by designating coordinates) after a predetermined input. When some region of the image is selected, the controller 180 may display the note setting object. When the note setting object is selected, the controller 180 may display the user interface for processing to change the image (video). The controller 180 may change the color of the image based on a user input and set the changed image as a screen off background. According to various exemplary embodiments, the controller 180 may reduce the size of the image.

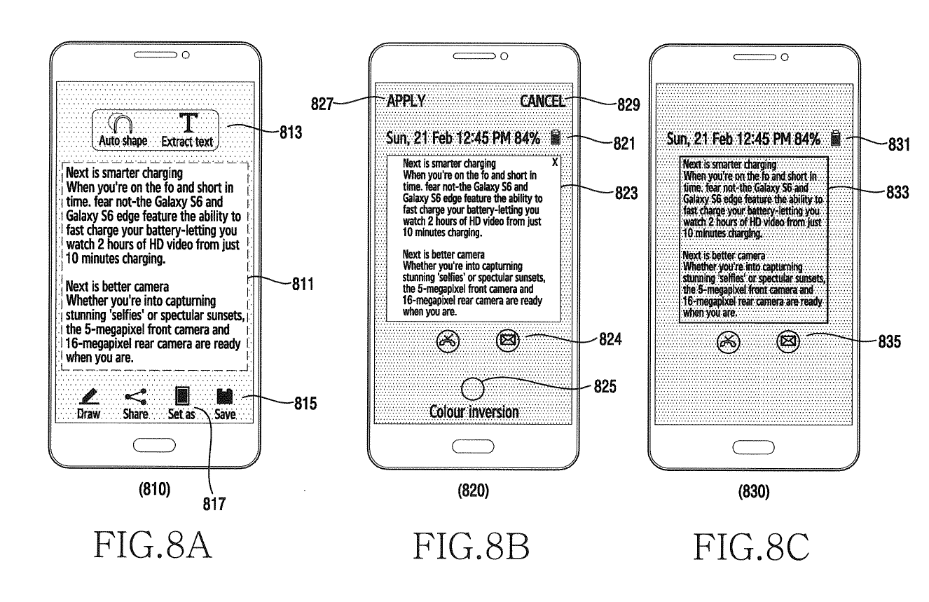

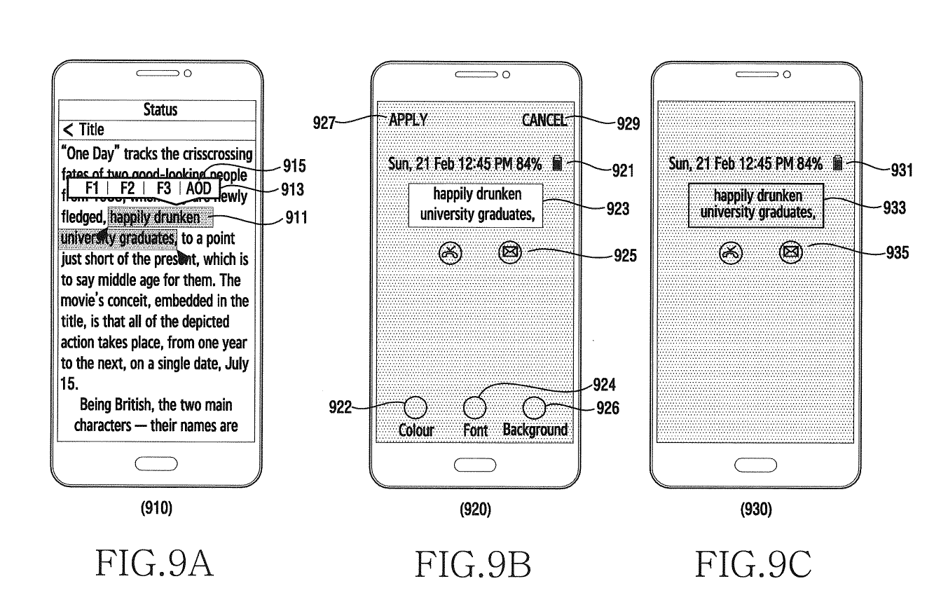

FIGS. 8A-8C and FIGS. 9A-9C are views showing examples of user interfaces related to setting of a screen off background according to various exemplary embodiments.

FIGS. 8A-8C are views showing examples of a user interface for setting an image as a screen off background.

Referring to FIG. 8A, the electronic device (for example, the controller 180) may display a first user interface 810 in which at least some region in the user interface is selected. For example, the user interface may be an execution screen of a web application. While the execution screen of the web application is being displayed, the controller 180 may detect an input of dragging, by a user, at least one of a text, an image, and a video with an electronic pen or a finger, or selecting coordinates after a predetermined input (for example, a long press). When the input of dragging some region or selecting coordinates after the predetermined input is detected, the controller 180 may display the first user interface 810.

The first user interface 810 may be a user interface which displays a region 811 selected in the user interface to be distinguished from a region which is not selected, and provides various function menus. For example, the first user interface 810 may blur the region which are not selected. In addition, the first user interface 810 may include function menu items 813 and 815 for executing functions regarding the selected region 811. The function menu items may include a first function menu item 813 including an auto shape menu and an extract text menu, and a second function menu item 815 including a draw menu, a share menu, a set as menu 817, and a save menu. That is, when a region is selected in the user interface, the first user interface 810 may display various function menus and display the selected region 811 to be distinguished from the unselected region.

According to various exemplary embodiments, when the set as menu 817 is selected in the first user interface 810, the electronic device (for example, the controller 180) may provide a user interface (for example, a second user interface 820) for processing to change the selected region. The set as menu 817 may be an icon for setting the selected region as a screen off background. The set as menu 817 may be a note setting object. The second user interface 820 may be to process to change the selected region with set information displayed in the screen off state. Since the display 131 is operated in a low power mode in the screen off state, the display region of the display 131 may be displayed in black and the set information (for example, a date, time, a battery state, or the like) may be displayed on some regions of the display region.

According to various exemplary embodiments, the set information which is displayed when the display 131 is operated in the low power mode may be different from information (or data) which is displayed when the display 131 is in a driving mode. For example, when the display 131 is driven in the low power mode, the display region of the display 131 may be displayed in a dark color (or black) and the set information may be displayed in a bright color (or white). When the display 131 is in the driving mode, the display region of the display 131 may be displayed in a bright color (or white) and the information may be displayed in a dark color (or black). That is, the set information which is displayed when the display 131 is driven in the low power mode, and the information displayed when the display 131 is in the driving mode may have opposite display colors. Accordingly, the controller 180 may need to change the selected region to have a similar format to that of the set information in order to set the selected region as the screen off background.

For example, the second user interface 820 may include first set information 821, second set information 824, a selected region 823, a change processing object 825, an apply object 827, and a cancel object 829. The background of the second user interface 820 may be displayed in a dark color (or black), and the first set information 821, the second set information 824, the change processing object 825, the apply object 827, and the cancel object 829 may be displayed in a bright color (for example, white) contrasting with the dark color. The first set information 821 may include at least one of a date, time, and a battery state. The second set information 824 may include an object (for example, an icon) related to an application. The background color and the letter color of the selected region 823 may be changed by the change processing object 825. The change processing object 825 may be an icon for reversing the color of the selected region 823.

According to various exemplary embodiments, the controller 180 may provide a different user interface according to data included in the selected region. The second user interface 820 may be provided when the selection region 823 is an image or a video. That is, the second user interface 820 may include only the change processing object 825 to reverse the color of the selected region 823. For example, when data included in the selected region 823 is an image or a video, the controller 180 may include only a color reversing object to change the color of the image or the video to a dark color (for example, black, grey). For example, the change processing object 825 may be a color reversing icon for changing the background to a dark color and changing a text color to white.

The user may select the change processing object 825 to change the selected region 823. When the change processing object 825 is selected, the controller 180 may change the color of the selected region 823. For example, the controller 180 may process the color of the selected region 823 to be grey. According to various exemplary embodiments, the controller 180 may change the color by a different ratio according to the number of times the change processing object 825 is selected. For example, when the change processing object 825 is selected once, the controller 180 may darken the color of the selected region 823 by 100%, and, when the change processing object 825 is selected twice, the controller 180 may darken the color of the selected region 823 by 90%. When the change processing object 825 is selected three times, the controller 180 may darken the color of the selected region 823 by 80%. Alternatively, the reverse is possible.

According to various exemplary embodiments, when the change processing object 825 is selected, the controller 180 may provide a function menu item including different ratios (for example, 100%, 90%, 80% or the like), and may receive selection of any one ratio in the function menu item and may darken the color of the selected region 823.

When the apply object 827 is selected, the controller 180 may provide a third user interface 830, and, when the delete object 829 is selected, the controller 180 may provide the first user interface 810.

The third user interface 830 may display the selected region with the set information in the screen off state. The third user interface 830 may include first set information 831, a selected region 833, and second set information 835. The first set information 831 may include at least one of a date, time, and a battery state. The second set information 835 may include an object (for example, an icon) related to an application. Comparing the selection region 833 of the third user interface 830 and the selected region 823 of the second user interface 820, the background of the selected region 833 is darkly displayed (for example, black), and the text of the selected region 833 is brightly displayed. In contrast to the selected region 833, the selected region 823 before being processed to be changed may have a bright (for example, white) background and a dark (for example, black) text.

FIGS. 9A-9C are views showing an example of a user interface for setting a text as a screen off background.

Referring to FIG. 9A, the electronic device (for example, the controller 180) may display a first user interface 910 in which at least some region in the user interface is selected. For example, the user interface may be an execution screen of an electronic book (e-book) application.

While displaying the execution screen of the e-book application, the controller 180 may detect an input of dragging, by a user, at least one of a text, an image, and a video with an electronic pen or a finger, or selecting coordinates after a predetermined input (for example, a long press). When the input of dragging some region or selecting coordinates after the predetermined input is detected, the controller 180 may display a first user interface 910.

The first user interface 910 may display a region 911 selected in the user interface to be distinguished from an unselected region, and may provide various function menus 913. For example, the first user interface 910 may have the selected region 911 processed to be darker than the unselected region. In addition, the first user interface 910 may include the function menu items 913 to perform functions regarding the selected region 911. The function menu items 913 may include F1, F2, F3, and AOD 915. That is, when a region is selected in the user interface, the first user interface 910 may display the various function menu items 913 and display the selected region 911 to be distinguished from the unselected region.

According to various exemplary embodiments, when the AOD 915 is selected in the first user interface 910, the electronic device (for example, the controller 180) may provide a user interface (for example, a second user interface 920) for processing to change the selected region. The AOD 915 may be an icon for setting the selected region as a screen off background. The AOD 915 may be a note setting object. The second user interface 920 may be to process to change the selected region with set information displayed in the screen off state. For example, the second user interface 920 may include first set information 921, second set information 925, a selected region 923, a first change processing object 922, a second change processing object 924, a third change processing object 926, an apply object 927, and a cancel object 929. The background of the second user interface 920 may be displayed in a dark color (or black), and the first set information 921, the second set information 925, the first change processing object 922, the second change processing object 924, the third change processing object 926, the apply object 927, and the cancel object 929 may be displayed in a bright color (for example, white) contrasting with the dark color.

The first set information 921 may include at least one of a date, time, and a battery state. The second set information 925 may include an object (for example, an icon) related to an application. The background color, the letter color, the letter style, or the letter size of the selected region 923 may be changed by at least one of the first change processing object 922, the second change processing object 924, or the third change processing object 926. The first change processing object 922 may be an icon for changing (or reversing) the text color of the selected region 923. The second change processing object 924 may be an icon for changing the text letter style of the selected region 923. The third change processing object 926 may be an icon for changing (or reversing) the background color of the selected region 923. Although not shown, a fourth change processing object for changing the text size of the selected region 923 may further be included in the second user interface 920.

The user may change the selected region 923 by selecting at least one of the first change processing object 922 to the third change processing object 926. When the first change processing object 922 is selected, the controller 180 may change the text color of the selected region 923. According to various exemplary embodiments, the controller 180 may change the color by a different color (brightness) ratio according to the number of times the first change processing object 922 is selected. According to various exemplary embodiments, when the first change processing object 922 is selected, the controller 180 may provide a function menu item including different colors (for example, a first color (for example, 100%), a second color (for example, 90%), or the like), and may receive selection of one color (or ratio) in the function menu item and may process the color (ratio) of the selected region 923 to be bright.

When the second change processing object 924 is selected, the controller 180 may change the letter style of the selected region 923. For example, when the second change processing object 924 is selected, the controller 180 may provide a function menu item including various letter styles, and may receive selection of any one letter style in the function menu item and change the letter style of the selected region 923. When the third change processing object 926 is selected, the controller 180 may change the background color of the selected region 923. According to various exemplary embodiments, the controller 180 may change the background color by a different ratio according to the number of times the third change processing object 926 is selected.

According to various exemplary embodiments, when the third change processing object 926 is selected, the controller 180 may provide a function menu item including different ratios (for example, 100%, 90%, 80%, or the like), and may receive selection of any one ratio in the function menu item and process the background color of the selected region 923 to be dark.

According to various exemplary embodiments, when one of the change processing objects is selected, the controller 180 may perform a function corresponding to another change processing object which is not selected. For example, when the first change processing object 922 is selected, the controller 180 may change the text color of the selected region 923 and may change the background color of the selected region 923 to contrast with the changed text color. Alternatively, when the third change processing object 926 is selected, the controller 180 may change the background color of the selected region 923 and may change the text color of the selected region 923 to contrast with the changed background color.

When the apply object 927 is selected, the controller 180 may provide a third user interface 930, and, when the delete object 929 is selected, the controller 180 may provide the first user interface 910.

The third user interface 930 may be to display the selected region with the set information in the screen off state. The third user interface 930 may include first set information 931, a selected region 933, and second set information 935. The first set information 931 may include at least one of a date, time, and a battery state. The second set information 935 may include an object (for example, an icon) related to an application. Comparing the selected region 933 of the third user interface 930 and the selected region 923 of the second user interface 920, the background of the selected region 933 may be displayed darkly (for example, black) and the text of the selected region 933 may be displayed brightly (for example, white). In contrast to the selected region 933, the selected region 923 before being processed to be changed has a bright (for example, white) background and a dark (for example, black) text.

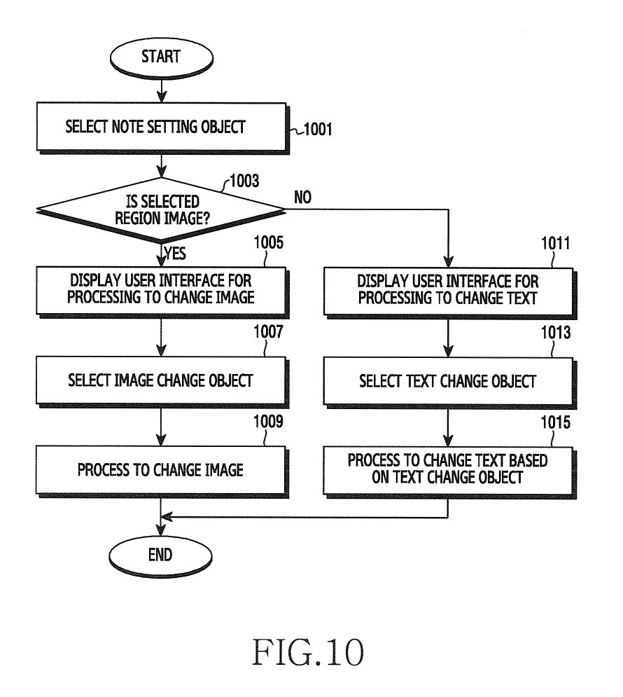

FIG. 10 is a flowchart showing a method for processing to change in an electronic device according to various exemplary embodiments. FIG. 10 illustrates operations 711 and 713 of FIG. 7 in detail.

Referring to FIG. 10, in operation 1001, the electronic device (for example, the controller 180) may receive selection of a note setting object. The note setting object may be an icon for setting a selected region as a screen off background. The note setting object has been described with reference to the above-described drawings and thus a detailed description thereof is omitted here.

In operation 1003, the electronic device (for example, the controller 180) may determine whether the selected region is an image or not. The selected region may refer to at least a part or an entirety being selected based on a user input on an execution screen of an application. For example, the controller 180 may provide a different user interface according to whether data included in the selected region is a text, an image, or a video. For example, when the selected region is an image, the controller 180 may perform operation 1005, and, when the selected region is not an image (for example, a text), the controller 180 may perform operation 1011.

When the selected region includes an image (or a video), the electronic device (for example, the controller 180) may display a user interface for processing to change the image (or video) in operation 1005. The user interface for processing to change the image may include a function menu item (for example, an image change object) for changing (or reversing) the color of the image (or video). For example, the controller 180 may display the second user interface 820 of FIG. 8B when the selected region includes an image (or video).

In operation 1007, the electronic device (for example, the controller 180) may receive selection of the image change object. The image change object may be an icon for changing the color of the image included in the selected region. The image change object may be the change processing object 825 included in the second user interface 820 of FIG. 8B. For example, the user interface for processing to change the image may include only one image change object to change the color of the image or reverse the color of the image and the color of the text each other, and may include one or more image change objects.

In operation 1009, the electronic device (for example, the controller 180) may process to change the image. For example, the controller 180 may reverse the color of the image (for example, change the color to a dark color (for example, black)) according to the user input in the user interface for processing to change the image. Alternatively, the controller 180 may reverse the color of the text included in the image and the background color each other according to a user input in the user interface for processing to change the image. For example, the controller 180 may change the color of the text included in the image to white and may change the background color of the image to black.

When the selected region includes a text, the electronic device (for example, the controller 180) may display a user interface for processing to change the text in operation 1011. The user interface for processing to change the text may include a function menu item (or object) for changing at least one of a background color, a text color, a text size, and a letter style (or font). For example, when the selected region includes a text, the controller 180 may display the second user interface 920 of FIG. 9B.

In operation 1013, the electronic device (for example, the controller 180) may select a text change object. The text change object may be an icon for changing at least one of a background color, a text color, a text size, and a letter style (or font). For example, the text change object may include at least one of a background color change object (for example, the third change processing object 926), a text color change object (for example, the first change processing object 922), a text size change object, and a letter style change object (for example, the second change processing object 924). That is, the text change object may be one or more objects unlike the image change object. The text change object may include the first change processing object 922, the second change processing object 924, the third change processing object 926, or the fourth change processing object (for example, a text size change object) included in the second user interface 920 of FIG. 9B.

In operation 1015, the electronic device (for example, the controller 180) may process to change the text based on the text change object. According to various exemplary embodiments, the controller 180 may change at least one of a color, a size, a letter style (or a font), a background color of the text according to the user input in the user interface for processing to change the text. For example, when the text color change object (for example, the first change processing object 922) is selected, the controller 180 may change the text color of the selected region. When the letter style change object (for example, the second change processing object 924) is selected, the controller 180 may change the letter style of the selected region. When the background color change object (for example, the third change processing object 926) is selected, the controller 180 may change the background color of the selected region. When the text size change object (for example, the fourth change processing object) is selected, the controller 180 may change the text size of the selected region.

According to various exemplary embodiments, when one text change object is selected, the controller 180 may perform a function corresponding to another text change object which is not selected. For example, when the text color change object is selected, the controller 180 may change the text color of the selected region and may change the background color of the selected region to contrast with the changed text color. Alternatively, when the background color change object is selected, the controller 180 may change the background color of the selected region and may change the text color of the selected region to contrast with the changed background color.

According to various exemplary embodiments, when the selected region includes both a text and an image (or video), the controller 180 may provide a user interface for processing to change the text (for example, the second user interface 920 of FIG. 9B). According to various exemplary embodiments, when the selected region includes an image and includes a text in the image, the controller 180 may provide a user interface for processing to change the image (for example, the second user interface 820 of FIG. 8B), or a user interface for processing to change the text (for example, the second user interface 920 of FIG. 9B). For example, when it is possible to extract the text included in the image, the controller 180 may provide a user interface for processing to change the text. In this case, the controller 180 may change at least one of a color, a letter style, and a size of the text included in the image, and a color of the image (for example, a background color) based on a user input. When it is not possible to extract the text included in the image, the controller 180 may provide a user interface for processing to change the image. In this case, the controller 180 may change only the color of the image (for example, a background color) based on a user input.

According to various exemplary embodiments, the controller 180 may provide a user interface for processing to change the image (for example, the second user interface 820 of FIG. 8B), or a user interface for processing to change the text (for example, the second user interface 920 of FIG. 9B) based on the size of the selected region. For example, when the size of the selected region is greater than or equal to a reference size, the controller 180 may provide the user interface for processing to change the image. When the size of the selected region is less than the reference size, the controller 180 may provide the user interface for processing to change the text.

Various exemplary embodiments described in the present disclosure may be implemented in a recording medium which is readable by a computer or a similar device thereto using software, hardware, or a combination thereof. According to hardware-based implementation, embodiments described in the present disclosure may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electric units for performing other functions.

According to an embodiment of the present disclosure, the recording medium may include a computer readable recording medium having a program recorded thereon, for executing operations of: detecting a note event in a screen off state; displaying a first user interface for writing a note on the display; receiving a note writing input from a user; and, when an object for fixed display included in the first user interface is selected, displaying a second user interface related to a note.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An electronic device comprising:
a display;
a memory; and
a processor functionally connected with at least one of the display or the memory, wherein the processor is configured to: detect a note event in a screen off state; display a first user interface for writing a note on the display; receive a note writing input from a user; and, if an object for fixed display included in the first user interface is selected, display a second user interface related to the written note.

2. The electronic device of claim 1, wherein the screen off state comprises a state in which the display is operated in a low power mode and set information is displayed, or a state in which the display is turned off and information is not displayed.

3. The electronic device of claim 1, wherein the note event comprises separating an electronic pen provided in the electronic device or a predetermined touch input.

4. The electronic device of claim 1, wherein the first user interface comprises a first layer for displaying a background of the display in a set color, and a second layer for displaying a user interface for writing the note.

5. The electronic device of claim 1, wherein, if the object for fixed display is selected, the processor is configured to convert the inputted note into an image and store the converted image in the memory.

6. The electronic device of claim 5, wherein the processor is configured to adjust a size of the inputted note and convert the note into an image.

7. The electronic device of claim 1, wherein the second user interface related to the written note comprises at least one of a third user interface comprising a note object informing that there is a written note, or a fourth user interface displaying a content of the written note.

8. The electronic device of claim 7, wherein, if the object for fixed display is selected, the processor is configured to display the third user interface in the screen off state, and, if the note object is selected, the processor is configured to display the fourth user interface in the screen off state.

9. The electronic device of claim 8, wherein, if a note fold object is selected in the fourth user interface, the processor is configured to convert the fourth user interface into the third user interface, or if a predetermined time elapses after the fourth user interface is displayed, the processor is configured to convert the fourth user interface into the third user interface.

10. The electronic device of claim 7, wherein the processor is configured to adjust a layout of the third user interface and display the fourth user interface.

11. The electronic device of claim 7, wherein the processor is configured to detect a note edit event while the second user interface is being displayed, load a note from the memory, display a fifth user interface for editing the loaded note, and edit the loaded note based on an input of the user.

12. The electronic device of claim 1, wherein, if the note event is detected, the processor is configured to determine whether there exists a written note, and, if there exists the written note, the processor is configured to perform a note edit process, and, if there does not exist the written note, the processor is configured to perform a note writing process.

13. The electronic device of claim 11, wherein the processor is configured to detect a user input of selecting a region in an execution screen of an application, display a note setting object, display a sixth user interface for processing to change the selected region if the note setting object is selected, change the selected region based on an input of the user, and set the changed region as a screen off background.

14. The electronic device of claim 13, wherein the processor is configured to display different sixth user interfaces based on a type of data included in the selected region.

15. A method of operating an electronic device, the method comprising:
detecting a note event in a screen off state;
displaying a first user interface for writing a note on a display;
receiving a note writing input from a user; and
if an object for fixed display included in the first user interface is selected, displaying a second user interface related to a note.

16. The method of claim 15, wherein the note event comprises separating an electronic pen provided in the electronic device or a predetermined touch input.

17. The method of claim 15, further comprising:
if the object for fixed display is selected, converting the inputted note into an image; and storing the converted image in a memory.

18. The method of claim 15, wherein the second user interface related to the note comprises at least one of a third user interface comprising a note object informing that there is a written note, or a fourth user interface displaying a content of the written note.

19. The method of claim 18, wherein displaying the second user interface comprises:
if the object for fixed display is selected, displaying the third user interface in the screen off state; and
if the note object is selected, displaying the fourth user interface in the screen off state.

20. The method of claim 19, further comprising:
if a note fold object is selected in the fourth user interface, converting the fourth user interface into the third user interface, or
if a predetermined time elapses after the fourth user interface is displayed, converting the fourth user interface into the third user interface.
